(19) United States
(12) Patent Application Publication
(10) Pub. No.: US 2020/0238114 A1
(43) Pub. Date: Jul. 30, 2020

(54) FIRE-FIGHTING TERMINAL, FIRE-FIGHTING SERVER, AND FIRE-FIGHTING MONITORING DEVICE

(71) Applicant: Shenzhen Fugui Precision Ind. Co., Ltd., Shenzhen (CN)

(72) Inventor: SHIH-CHENG WANG, New Taipei (TW)

(21) Appl. No.: 16/366,180

(22) Filed: Mar. 27, 2019

(30) Foreign Application Priority Data
Jan. 29, 2019 (CN) 201910087851.7

(51) Int. Cl. A62C 37/00; H04W 84/18; G06Q 50/26

(52) U.S. Cl. CPC A62C 37/00; G08B 25/10; G06Q 50/26; H04W 84/18

(57) ABSTRACT

A fire-fighting terminal, establishing a communication connection with at least one fire-fighting server, and comprising at least one firefighter; an acquisition unit configured for collecting image information of the fire-fighting equipment; a detecting unit configured for detecting physical information of the fire-fighting equipment; and a communication unit configured for communicating with the fire-fighting server. A fire-fighting server and a fire-fighting monitoring device are also provided.

### FIELD

The disclosure generally relates to fire-fighting technology.

### BACKGROUNDING

Inspection and maintenance of fire-fighting terminals is essential for fire prevention. Therefore, routine inspections of fire-fighting terminals are required. However, inspecting thousands of fire extinguishers in large industrial plants is difficult to achieve in a timely and comprehensive manner by means of manual inspection.

Therefore, there is room for improvement within the art.

### BRIEF DESCRIPTION OF THE DRAWING

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a schematic diagram of a fire-fighting inspection system in accordance with an embodiment of the present disclosure.

FIG. 2 is a schematic diagram of a fire-fighting terminal in accordance with an embodiment of the present disclosure.

FIG. 3 is a schematic diagram of a fire-fighting server in accordance with an embodiment of the present disclosure.

FIG. 4 is a functional module schematic diagram of a fire-fighting data processing system in accordance with an embodiment of the present disclosure.

FIG. 5 is a schematic diagram of a fire-fighting monitoring device in accordance with an embodiment of the present disclosure.

FIG. 6 is a functional module schematic diagram of a fire-fighting monitoring system in accordance with an embodiment of the present disclosure.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series, and the like. The term “coupled” is defined as connected, whether directly or indirectly through intervening components, and is not necessarily limited to direct physical connection. The connection can be such that the objects are permanently connected or releasably connected.

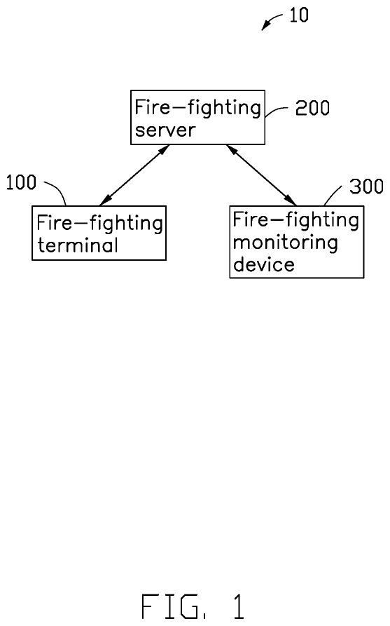

FIG. 1 shows a fire-fighting inspection system 10 in accordance with an embodiment of the present disclosure. The fire-fighting inspection system 10 includes at least one fire-fighting terminal 100, at least one fire-fighting server 200, and at least one fire-fighting monitoring device 300. The fire-fighting terminal 100 and the fire-fighting monitoring device 300 communicate with the fire-fighting server 200.

The fire-fighting terminal 100 acquires information related to fire-fighting equipment and uploads the related information to the fire-fighting server 200. The fire-fighting server 200 analyzes the related information and transmits analysis to the fire-fighting monitoring device 300. The fire-fighting monitoring device 300 displays the analysis for the monitoring personnel to perform a specific inspection on the fire-fighting equipment according to the analysis.

The fire-fighting terminal 100 includes at least one fire-fighting equipment and a detection device. The fire-fighting server 200 can be, but is not limited to, a general network server or a cloud server. The fire-fighting monitoring device 300 can be, but is not limited to, a smartphone, a tablet, or a computer.

In at least one embodiment, the state of the firefighting equipment is collected in real time by the fire-fighting terminal 100 and sent to the fire-fighting server 200 for analysis, and the analysis is displayed in the fire-fighting monitoring device 300. The fire-fighting inspection system 10 adopts IoT (Internet of Things) technology, and can perform a large number of automatic operations such as patrol inspection, problem notification and tracking, recording, etc., and effectively improving the efficiency of the inspection.

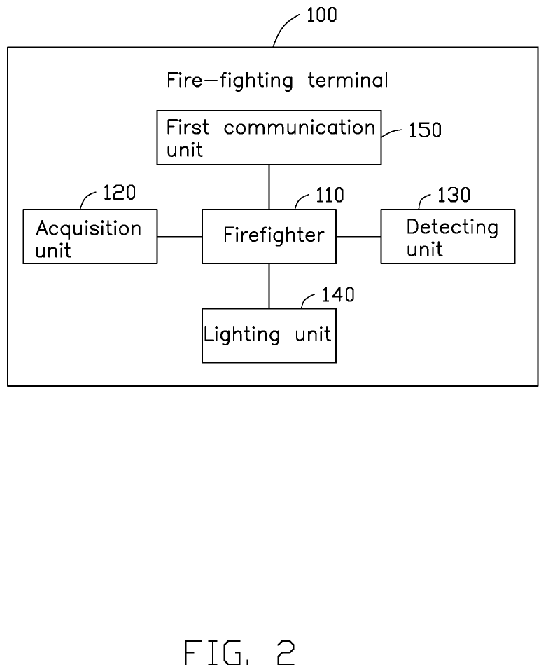

FIG. 2 shows a fire-fighting terminal 100 in accordance with an embodiment of the present disclosure. In the present embodiment, the fire-fighting terminal 100 includes at least one fire-fighting equipment 110, an acquisition unit 120, a detecting unit 130, a lighting unit 140, and a first communication unit 150.

The fire-fighting equipment 110 can be fire rescue and fire assist equipment. Specifically, the fire rescue equipment includes one or more of a fire extinguisher and a fire hydrant. The fire assist equipment includes one or more of a mask, a fire blanket, and a fire alarm. The fire-fighting equipment 110 is pre-coded for easy searching.

The acquisition unit 120 collects image information of the fire-fighting equipment 110. The acquisition unit 120 can be, but is not limited to, a video camera, an industrial camera, and the like. The image information includes one or more of a video, a picture, and a sound of the fire-fighting equipment 110. The picture can show that the fire-fighting equipment 110 is dumped, damaged or connected abnormally. The sound can indicate air leakage or water leakage of the fire-fighting equipment 110.

The detecting unit 130 detects physical information of the fire-fighting equipment 110. The detecting unit 130 can be, but is not limited to, a pressure sensor, a weight sensor, a temperature sensor, a humidity sensor, or a position sensor. The physical information includes one or more of a pressure, a weight, a temperature, a humidity, and a position of the fire-fighting equipment 110. The physical information can indicate an abnormal state of the fire-fighting equipment 110.

The lighting unit 140 provides illumination to the acquisition unit 120. The lighting unit 140 can be, but is not limited to, an energy saving lamp, an LED lamp, or a remote control lamp. Since the lighting unit 140 provides illumination to the acquisition unit 120, the acquisition unit 120 may acquire image information in a dark environment. The lighting unit 140 may be eliminated in some cases where no illumination is required.

The first communication unit 150 establishes a communication connection with the fire-fighting server 200. In the present embodiment, the fire-fighting terminal 100 communicates with the fire-fighting server 200 via a wireless network. The wireless network can be, but is not limited to, WI-FI, Bluetooth, cellular mobile network, satellite network, and the like. Through the first communication unit 150, the fire-fighting terminal 100 can transmit the images and the physical information to the fire-fighting server 200.

By using the fire-fighting terminal 100 provided by the present disclosure, it is possible to record, track, and audit the inspection work at any time, without manpower, time, or location constraints.

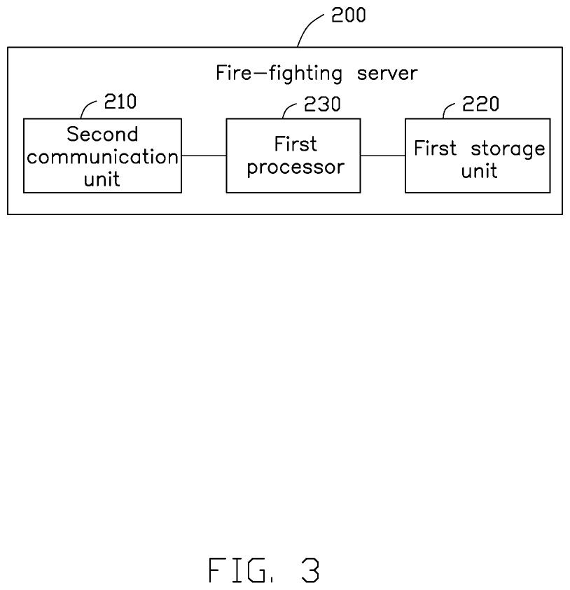

FIG. 3 shows the fire-fighting server 200 in accordance with an embodiment of the present disclosure. In the present embodiment, the fire-fighting server 200 includes a second communication unit 210, a first storage unit 220, and a first processor 230.

The second communication unit 210 establishes communication with the fire-fighting terminal 100 and the fire-fighting monitoring device 300. In the present embodiment, the second communication unit 210 can establish a communication with the fire-fighting monitoring device 300 by wire or wirelessly. The second communication unit 210 can establish a communication with the fire-fighting terminal 100 via a wireless network. The wireless network can be, but is not limited to, WI-FI, Bluetooth, cellular mobile network, satellite network, and the like.

The first storage unit 220 stores data in the fire-fighting server 200, such as a database, program code, and the like. The first storage unit 220 can be a read-only memory, a random access memory, a programmable read-only memory, an erasable programmable read-only memory, a one-time programmable read-only memory, or an electrically-erasable programmable read-only memory. The first storage unit 220 can also be an optical disk storage, a magnetic disk storage, a magnetic tape storage, or any other medium readable by a computer that can be used to store data.

In the present embodiment, the first storage unit 220 stores an information database including the image information, the physical information, and the code of the fire-fighter 110. The image information includes one or more of a video, a picture, and a sound of the fire-fighting equipment 110. The physical information includes one or more of a pressure, a weight, a temperature, a humidity, and a position of the fire-fighting equipment 110.

The first storage unit 220 also stores a standard information in the normal state of the fire-fighting equipment 110. The first processor 230 can be, but is not limited to, a central processor, a micro-processor, or a digital processing chip.

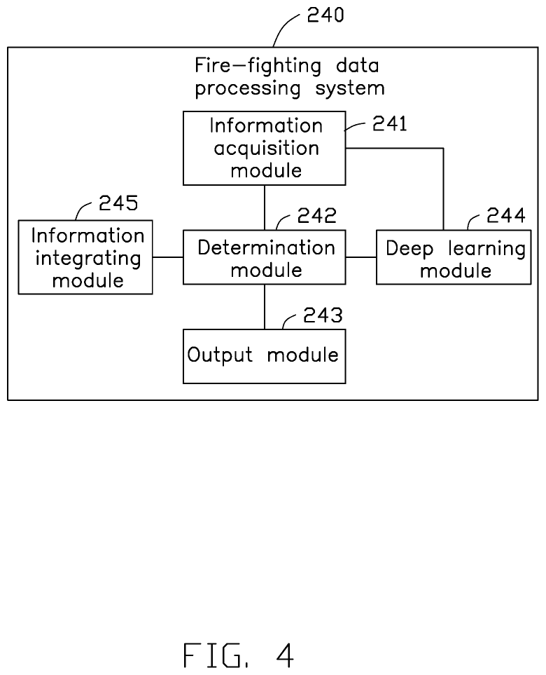

FIG. 4 shows a fire-fighting data processing system 240 running in the fire-fighting server 200. The fire-fighting data processing system 240 includes computer instructions in the form of one or more programs. The computer instructions are stored in the first storage unit 220 and executed by the first processor 230. In the present embodiment, the fire-fighting data processing system 240 includes an information acquisition module 241, a determination module 242, and an output module 243.

The information acquisition module 241 obtains fire-fighting equipment code, image information and physical information of the fire-fighting terminal 100. The fire-fighting equipment code may include, but is not limited to, a name, a user, and a location of the fire-fighting equipment 110. The image information includes one or more of a video, a picture, and a sound of the fire-fighting equipment 110. The physical information includes one or more of a pressure, a weight, a temperature, a humidity, and a position of the fire-fighting equipment 110.

The determination module 242 determines whether the image information or the physical information has abnormal information indicating that the fire-fighting equipment 110 is in an abnormal state. The image information and the physical information are compared with the standard information in the normal state of the fire-fighting equipment 110 to determine whether or not the abnormal information exists. For example, the picture can indicate whether the fire-fighting equipment 110 is dumped, damaged or connected abnormally. The sound can indicate whether the fire-fighting equipment 110 has air leakage or water leakage. The weight and the pressure of the physical information can determine whether the fire-fighting equipment 110 is within normal ranges. The humidity of the physical information can indicate that the fire blanket is safe to use or not safe to use.

The output module 243 outputs the abnormal information to the fire-fighting monitoring device 300.

In at least one embodiment, the fire-fighting data processing system 240 further includes a deep learning module 244, and an information integrating module 245.

The deep learning module 244 establishes a deep learning evaluation model, and trains the deep learning evaluation model to obtain a fire-fighter deep learning evaluation model. Specifically, the deep learning evaluation model is established by using an existing engineering deep learning model, and further, the deep learning evaluation model is trained by using the image information and the physical information until the fire-fighting deep learning evaluation model is obtained.

The determination module 242 further determines whether the image information or the physical information has the abnormal information by using the fire-fighting deep learning evaluation model. The abnormal information has been described previously.

The information integrating module 245 integrates the image information and the physical information. If the fire-fighting equipment 110 does not have the abnormal information, the image information and the physical information are integrated. The information integration specifically includes the steps of counting the image information and the physical information, recording the image information and the physical information, and updating the image information and the physical information.

Counting the image information and the physical information avoids the omission of information from the fire-fighting equipment 110. Recording the image information and the physical information allows the monitoring personnel to retrieve the information at any time for convenient unified management. Updating the image information and the physical information allows the fire-fighting server 200 to store the latest information of the fire-fighting equipment 110, to prevent the occurrence of long-term information affecting the determination of the abnormal information.

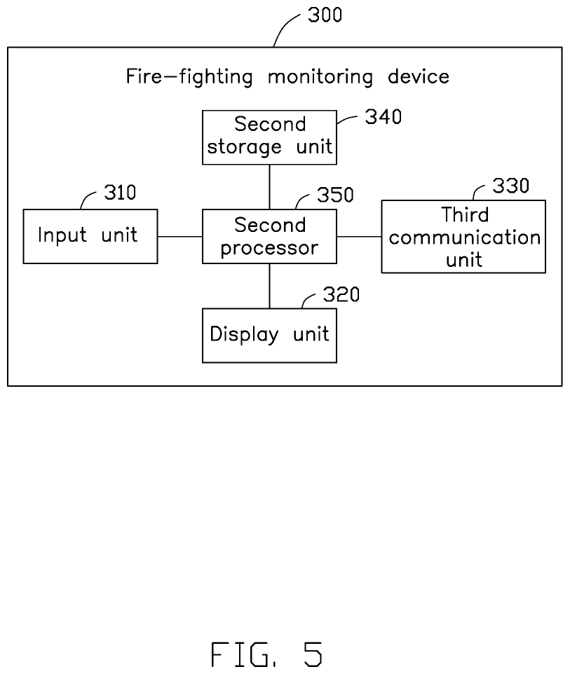

FIG. 5 shows the fire-fighting monitoring device 300 in accordance with an embodiment of the present disclosure. In the present embodiment, the fire-fighting monitoring device 300 includes an input unit 310, a display unit 320, a third communication unit 330, a second storage unit 340, and a second processor 350.

The input unit 310 allows the user to input information and control instructions. In the present embodiment, the input unit 310 can be, but is not limited to, a touch screen, a mouse, a keyboard, or a voice recognition device.

The display unit 320 displays information of the fire-fighting monitoring device 300. In the present embodiment, the display unit 320 can be, but is not limited to, a touch screen, or a liquid crystal display.

The third communication unit 330 establishes a communication with the fire-fighting server 200. In the present embodiment, the third communication unit 330 can establish a communication with the fire-fighting server 200 by wire or wirelessly.

The second storage device 340 stores data in the fire-fighting monitoring device 300, such as a program code, and the like. The second storage device 340 can be a read-only memory, a random access memory, a programmable read-only memory, an erasable programmable read-only memory, a one-time programmable read-only memory, or an electrically-erasable programmable read-only memory. The second storage device 340 can also be an optical disk storage, a magnetic disk storage, a magnetic tape storage, or any other medium readable by a computer that can be used to store data.

The second processor 350 can be, but is not limited to, a central processor, a micro-processor, or a digital processing chip.

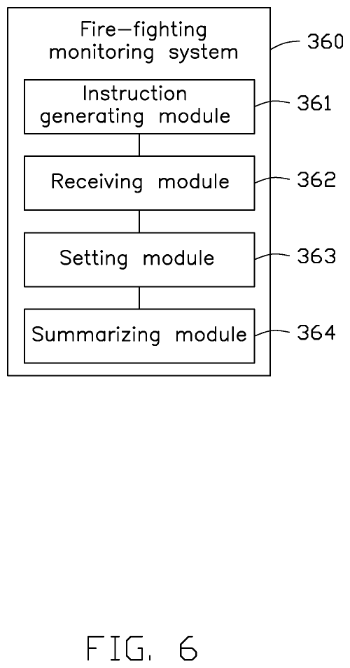

FIG. 6 shows a fire-fighting monitoring system 360 running in the fire-fighting monitoring device 300. The fire-fighting monitoring system 240 includes computer instructions in the form of one or more programs. The computer instructions are stored in the second storage device 340 and executed by the second processor 350. In the present embodiment, the fire-fighting monitoring system 360 is an application or program that can be downloaded by the user. The fire-fighting monitoring system 360 includes an instruction generating module 361, a receiving module 362, a setting module 363, and a summarizing module 364.

The instruction generating module 361 generates a control instruction according to an operation of a user. The receiving module 362 receives the abnormal information sent by the fire-fighting server 200. The receiving module 362 further receives the image information and the physical information sent by the fire-fighting server 200.

The setting module 363 formulates a maintenance schedule according to the abnormal information, and displays the maintenance schedule on the display unit 320. Specifically, the maintenance schedule is formulated according to the degree of danger of the abnormal information. The maintenance schedule includes the project, the manufacturer, the inspection date, the inspector, the maintenance record, and the like.

The summarizing module 364 summarizes the abnormal information, the image information, and the physical information to obtain a monitoring report. The monitoring report is displayed by the display unit 320. The monitoring report can generate a rate and frequency of maintenance. The monitoring personnel can analyze failures of the fire-fighting terminal 100 according to the maintenance rate, thereby enhancing management and ensuring that the fire-fighting equipment 110 can always be normally used.

The fire-fighting monitoring device 300 provided by the present disclosure realizes rapid and efficient inspection of fire-fighting equipment 110, timely discovery of problems, and risk of hidden dangers. The fire-fighting monitoring device eliminates the need for manual labor in the general routine inspection process.

The fire-fighting monitoring system 10 provided by the present disclosure avoids the disadvantages of manual inspection, such as difficulties arising from an environment, and avoids damage or deterioration to the fire-fighting equipment 110 caused by the manual inspection process. The fire-fighting monitoring system 10 provided by the present disclosure provides rapid and multiple preliminary inspections, and can be automatically notified after abnormal information. The fire-fighting monitoring system 10 provides indicators and prevention management of the fire-fighting terminals 100 through data analysis and calculation.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A fire-fighting terminal, establishing a communication connection with at least one fire-fighting server, and comprising:
at least one fire-fighting equipment;
an acquisition unit configured for collecting image information of the fire-fighting equipment;
a detecting unit configured for detecting physical information of the fire-fighting equipment; and
a communication unit configured for communicating with the fire-fighting server.

2. The fire-fighting terminal as claimed in claim 1, wherein the image information comprises one or more of a video, a picture, and a sound of the fire-fighting equipment.

3. The fire-fighting terminal as claimed in claim 1, wherein the physical information comprises one or more of a temperature, a humidity, a pressure, and a position of the fire-fighting equipment.

4. The fire-fighting terminal as claimed in claim 1, wherein the fire-fighting terminal further comprises a lighting unit configured for providing illumination to the acquisition unit.

5. The fire-fighting terminal as claimed in claim 4, wherein the lighting unit is an energy saving lamp, an LED lamp, or a remote control lamp.

6. The fire-fighting terminal as claimed in claim 1, wherein the fire-fighting equipment comprises one or more of a fire extinguisher, a fire hydrant, a mask, a fire blanket, and a fire alarm.

7. The fire-fighting terminal as claimed in claim 1, wherein the fire-fighting equipment is pre-coded for easy searching.

8. The fire-fighting terminal as claimed in claim 1, wherein the fire-fighting terminal is communicated with the fire-fighting server via a wireless network.

9. A fire-fighting server, establishing communication connections with at least one fire-fighting terminal and at least one fire-fighting monitoring device, the fire-fighting server comprising:
a processor; and
a storage unit configured for storing image information and physical information of the fire-fighting terminal,
the storage unit further stores one or more programs, when executed by the processor, the one or more programs cause the processor to:
obtain the image information and the physical information of the fire-fighting terminal;
determine whether the image information or the physical information has abnormal information;
when the image information or the physical information has abnormal information, send the abnormal information to the fire-fighting monitoring device;
when the image information or the physical information does not have abnormal information, integrate the image information and the physical information.

10. The fire-fighting server as claimed in claim 9, wherein the one or more programs further cause the processor to:
establish a deep learning evaluation model;
train the deep learning evaluation model with the image information and the physical information; and
obtain a fire-fighting deep learning evaluation model.

11. The fire-fighting server as claimed in claim 10, wherein the one or more programs further cause the processor to:
determine whether the image information or the physical information has abnormal information according to the fire-fighting deep learning evaluation model;
when the image information or the physical information has abnormal information, send the abnormal information to the fire-fighting monitoring device;
when the image information or the physical information does not have abnormal information, integrate the image information and the physical information.

12. The fire-fighting server as claimed in claim 9, wherein the process of integrating the image information and the physical information comprises:
counting the image information and the physical information;
recording the image information and the physical information; and
updating the image information and the physical information.

13. The fire-fighting server as claimed in claim 9, wherein the storage unit also stores a standard information in the normal state of the fire-fighting terminal, the image information and the physical information are compared with the standard information to determine whether or not the abnormal information exists.

14. The fire-fighting server as claimed in claim 9, wherein the fire-fighting terminal is communicated with the fire-fighting server via a wireless network.

15. A fire-fighting monitoring device, establishing a communication connection with at least one fire-fighting server, and comprising an input unit, a display unit, a processor, and a storage unit, wherein the storage unit stores a plurality of program modules, the plurality of program modules are executed by the processor and perform the followed steps:
generating a control instruction according to an operation of a user;
receiving abnormal information sent by the fire-fighting server;
formulating a maintenance schedule according to the abnormal information, and displaying the maintenance schedule on the display unit.

16. The fire-fighting monitoring device as claimed in claim 15, wherein the fire-fighting server is configured for communicating with at one fire-fighting terminal, obtaining image information and physical information of the fire-fighting terminal, and determining whether the image information or the physical information has the abnormal information.

17. The fire-fighting monitoring device as claimed in claim 16, wherein the plurality of program modules are executed by the processor and further perform the followed steps:
receiving image information and physical information sent by the fire-fighting server;
summarizing the abnormal information, the image information, and the physical information to obtain a monitoring report; and
displaying the monitoring report on the display unit.

18. The fire-fighting monitoring device as claimed in claim 16, wherein the image information comprises one or more of a video, a picture, and a sound of the fire-fighting equipment.

19. The fire-fighting monitoring device as claimed in claim 16, wherein the physical information comprises one or more of a temperature, a humidity, a pressure, and a position of the fire-fighting equipment.

20. The fire-fighting server as claimed in claim 16, wherein the fire-fighting terminal is communicated with the fire-fighting server via a wireless network.
